(19) United States
(12) Patent Application Publication
(10) Pub. No.: US 2015/0324761 A1
(43) Pub. Date: Nov. 12, 2015

(54) System and Method for Recycling Electronics While Complying with Secondhand Transaction Reporting Laws

(71) Applicants: Tu Nguyen, Fremont, CA (US); Michael Smithwick, San Jose, CA (US)

(72) Inventors: Tu Nguyen, Fremont, CA (US); Michael Smithwick, San Jose, CA (US)

(21) Appl. No.: 14/804,101

(22) Filed: Jul. 20, 2015

Related U.S. Application Data
(63) Continuation-in-part of application No. 14/328,661, filed on Jul. 10, 2014.
(60) Provisional application No. 62/026,042, filed on Jul. 18, 2014.
(60) Provisional application No. 61/979,703, filed on Apr. 15, 2014.

(51) Int. Cl. G06Q 10/00; G06Q 20/18; G06Q 30/00

(52) U.S. Cl. CPC G06Q 10/30; G06Q 30/018; G06Q 20/18

(57) ABSTRACT

A system and method for recycling used electronic devices in a kiosk or a desktop device while reporting the transaction to law enforcement in a manner required by the local jurisdiction for secondhand dealers.

### CROSS-REFERENCE TO RELATED APPLICATIONS

The present application is a continuation in part of application Ser. No. 14/328,661, filed Jul. 10, 2014, which takes priority from Provisional Application No. 61/979,703, filed on Apr. 15, 2014, and takes priority from Provisional Application No. 62/026,042, filed Jul. 18, 2014, which are herein incorporated by reference.

### STATEMENT REGARDING FEDERALLY SPONSORED RESEARCH AND DEVELOPMENT

Not Applicable.

### BACKGROUND

1. Field of the Invention

The present invention relates generally to recycling electronic devices, and more specifically, to a system and method for reporting secondhand transactions to law enforcement as applicable to recycling electronics by using a semi-automated kiosk or a trade-in assistant device.

2. Description of the Related Art

The resale of used electronic devices is a tightly regulated industry. Since the theft of electronic devices is rampant, many municipalities require any sales of secondhand goods (including electronic devices) to be reported to the police, and any reseller of secondhand goods to be registered with the police.

Since each transaction needs to be reported on a form, the reporting process is easy and quick and not terribly onerous when a store clerk is performing the action. However, if the electronic device is being sold in an automated kiosk or in a retail store assisted by an electronics trade-in assistant device, reporting each transaction on a form may be more complicated and may result in incomplete or incorrect forms. An electronics trade-in assistant device is any device that assists a store clerk in evaluating and valuing a used electronic device brought in by a customer for trade or resale.

A need therefore exists for a system and method for an automated kiosk or trade-in assistant device or other automated device for selling secondhand electronic devices to derive the information needed to fill out any forms required by law enforcement for reporting secondhand goods transactions, and to transmit them to law enforcement completely and in a timely way.

### SUMMARY OF THE INVENTION

An object of the present invention is to enable a consumer to easily recycle, donate, trade-in, or sell their unwanted electronic devices while also automatically reporting the transaction to law enforcement as required by the local jurisdiction.

Another object of the present invention is to enable easy determination of whether or not the device the consumer is trying to recycle, donate, trade-in, or sell is stolen while reporting the transaction to law enforcement in a way appropriate for the local jurisdiction.

Another object of the present invention is to provide a simple method of evaluating and collecting unwanted electronic devices that makes the device accessible to the consumer throughout the process of evaluation, until the device is collected and the money disbursed, while reporting the transaction to law enforcement in a way appropriate for the local jurisdiction.

Another object of the present invention is to provide a quick method of recycling, donating, trading-in, or selling unwanted electronic devices, while reporting the transaction to law enforcement in a way appropriate for the local jurisdiction.

In its preferred embodiment, the present invention is a system for recycling electronics, comprising a kiosk housing, a device examination area, a user interface, and a processor, where the processor is configured to communicate with an electronic device (such as a smartphone, a cell phone, an mp3 player, a mobile computer, a portable game, a camera, or the like), identify the device, determine whether or not the electronic device is likely to have been stolen, and reject the device if it is determined that the device is likely to have been stolen. If the device is determined to not be likely to have been stolen, the processor is configured to perform a functional test on the device, and in some embodiments, also to perform a cosmetic evaluation on the device, determine an appropriate compensation value for the device, and offer the compensation value to the user. The processor is then configured to collect any information from the user required by law enforcement for reporting secondhand transactions, automatically generate a report of the secondhand transaction for law enforcement use, and transmit the report of the secondhand transaction to law enforcement.

In some embodiments, the system also comprises a printer, wherein the processor is configured to direct the printer to print out at least one form required by law enforcement for reporting secondhand transactions.

In some embodiments, the system also comprises a biometric evaluation device that captures at least some biometric information from the user. Such biometric information may be fingerprints, face images, retina scans, or the like. The processor then collects information from the biometric device for the purpose of reporting secondhand transactions to law enforcement.

In some embodiments, the system also comprises a scanner. The processor then directs the scanner to scan a user's ID for the purpose of reporting secondhand transactions to law enforcement.

In its preferred embodiment, the method of the present invention comprises receiving an electronic device from a user (the electronic device being a smartphone, cell phone, mp3 player, mobile computer, or portable game), communicating with the electronic device, determining the brand, model, and serial number of the electronic device, determining whether the device is likely to be stolen and rejecting it if it is, performing a functional and cosmetic evaluation of the device, determining an appropriate compensation value for the device, offering it to the user, and then collecting identification information from the user, using the identification information to generate a form for reporting the transaction to law enforcement, and transmitting the form to law enforcement.

The identification information collected from the user can be an image of an identification document, a fingerprint, a signature, a retinal scan, the user's name, address, and date of birth, or an image of the user's face.

In an embodiment, the form is generated as a printed-out paper form, and mailed to the appropriate law enforcement department. In another embodiment, the form is generated as an electronic file and transmitted to the appropriate law enforcement department via the Internet.

Another embodiment of the present invention is a system for recycling electronics comprising a desktop-sized housing, a device interface, a user interface, a communication module, and a processor where the processor can communicate with an electronic device (such as a smartphone, cell phone, mp3 player, mobile computer or portable game), identify the device, determine whether the device is likely to have been stolen (and reject it if it is), perform a functional test on the electronic device, determine an appropriate compensation value for the electronic device, offer the compensation value to the user, collect any information from the user required by local law enforcement, automatically generate a report of the secondhand transaction for law enforcement, and transmit the report of the secondhand transaction to law enforcement. The transmission can happen via mailing in a printed-out form, or via the Internet.

In an embodiment, the system comprises at least one biometric device, which is used to collect information for the purpose of reporting secondhand transactions to law enforcement. The biometric device could be a fingerprint reader, a retina scanner, a face scanner, or any other device.

In an embodiment, the system also comprises a scanner, which is used to scan a user's ID for the purpose of reporting secondhand transactions to law enforcement.

### LIST OF FIGURES

FIG. 1 shows a kiosk of the present invention.

FIG. 2 shows an interior view of the kiosk of the present invention.

FIG. 3 shows a flowchart of the operation of the kiosk of the present invention.

FIG. 4 shows a view of the cosmetic scanning arm for an embodiment of the present invention.

FIG. 5 shows a sample JUS123 form used for reporting secondhand transactions to law enforcement.

### DETAILED DESCRIPTION OF THE PREFERRED EMBODIMENT

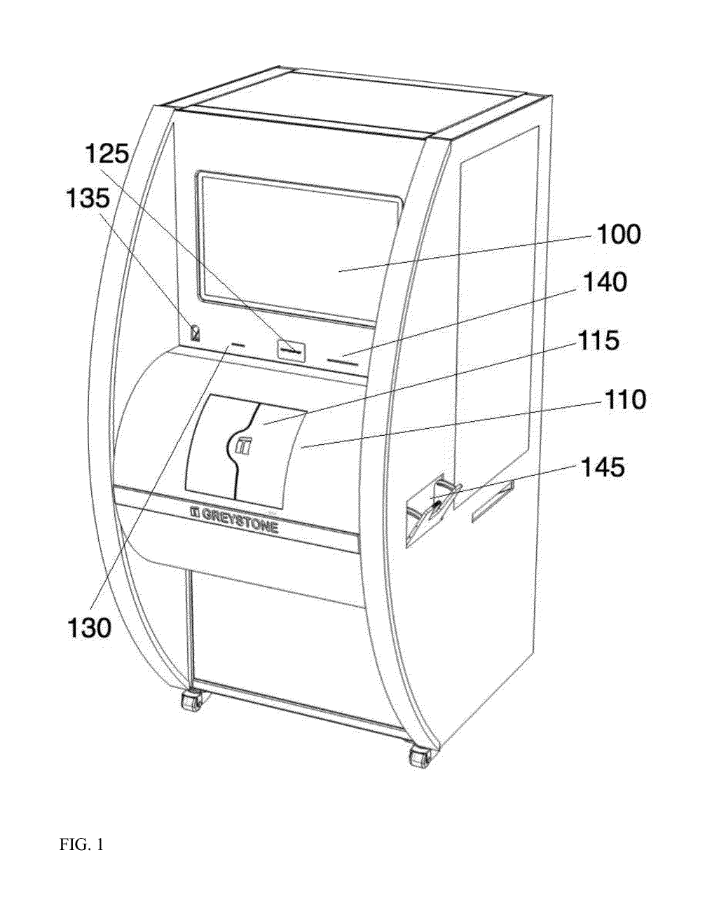

FIG. 1 shows a kiosk according to the preferred embodiment of the present invention. The kiosk is approximately the same size as a typical vending machine and is preferably located in a public place such as a shopping mall, a grocery store, a library, a gas station, or any other publicly accessible location. Touchscreen 100 serves as the user interface. In an embodiment, a speaker may also be used to play sounds or to give verbal instructions to the user. When the kiosk is not in use, the touchscreen 100 may be turned off, or may display advertisements. Inspection area 110 is where the user is expected to put the device, and comprises a set of sliding doors 115 that enclose an area big enough to accommodate the size of a typical electronic device. During the transaction, these doors are fully open and the user has the option of withdrawing the electronic device at any time, until the user accepts the offer. After the user accepts the price offer, the sliding doors close and the device is no longer accessible.

The kiosk also preferably comprises a credit card reader 125, an ID scanner 130, a fingerprint reader 135, and a printer 140 for printing receipts and labels. In an embodiment, the kiosk may also comprise a signature pad to collect the user's signature. The kiosk may also comprise any other device for collecting biometric or identification information, such as a passport scanner, a retina scanner, a DNA analyzer, a voice analyzer, a face recognition module, and so on.

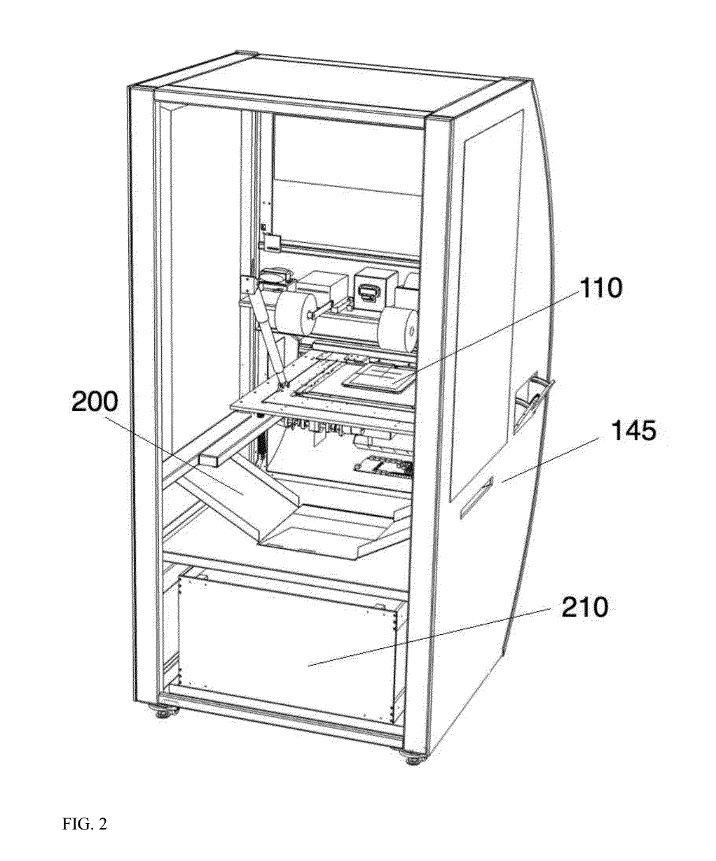

FIG. 2 shows a rear view of the kiosk according to the preferred embodiment of the present invention. It shows the inspection area 110, a chute 200, and a receptacle 210 where purchased electronic devices are stored after going through the transaction process. After an electronic device is accepted, it is directed onto the chute 200 and slides into the receptacle 210 for storage. A worker can then regularly collect the electronic devices from the receptacle as it fills up.

In an embodiment of the kiosk of the present invention, a slot 145 on the side of the kiosk is used to accept electronic devices for donation or recycling, but not for repurchase. Accepting a nonfunctional device for repurchase, however cheaply, would mean that an enterprising thief who cannot disable the theft-detection function can simply break the device and resell it at an automated kiosk. To remove any incentive for such behavior, the kiosk of the present invention does not accept nonfunctional devices for repurchase, but only for recycling or donation.

The kiosk preferably comprises a processor and a memory that is sufficient for storing and executing the instructions required for the functions described in the present application. In the preferred embodiment, the kiosk also comprises a connectivity module that is used to connect the kiosk to an online server. The connectivity module may use wired, wireless, 3G, 4G, or any other connection for that purpose.

The kiosk preferably also comprises information gathering devices that collect information required for the reporting of a secondhand goods transaction. For example, such information gathering devices may be fingerprint readers, cameras to take a picture of the customer's face, a touchscreen to enable the customer to input information, a driver's license scanner, a passport scanner, a signature pad, biometrics identification modules, and so on. The information gathering devices may also identify the electronic device rather than the customer; the kiosk is preferably able to connect to the used electronic device to determine its device ID, make, model, year of manufacture, and so on.

The kiosk's processor is preferably configured in such a way that it can analyze the information provided by the information gathering devices and use the information to fill out any forms required by law enforcement in the particular jurisdiction where the kiosk is located. For example, in California, the kiosk may automatically fill out a JUS123 form, which requires a fingerprint, a signature, the name and address of the customer, identification of the goods being sold, and so on. Other jurisdictions may require different information to be reported or may use different forms to report the transaction.

Once the kiosk fills out the form, it may electronically transmit the form to the police department of the municipality where it is located, or it may print out a paper form if the police department does not accept electronic forms. If the kiosk prints out paper forms, it may collect those forms in a receptacle until a worker can pick them up and mail them to the police department, or transmit those forms to the police department by fax.

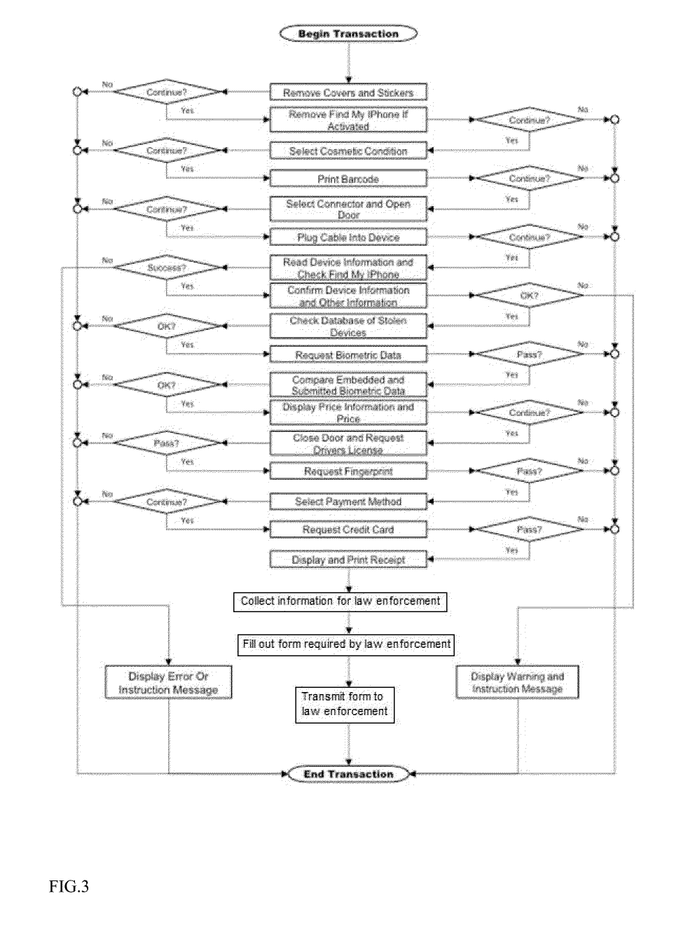

FIG. 3 shows the preferred embodiment of the method of the present invention. First, a user approaches the kiosk, which triggers the display to turn on. The display instructs the user to remove any stickers or covers from their phone and to unlock or remove any theft protection on the phone (such as FindMyIphone or similar software; note that while FIG. 3 only refers to “Find My iPhone”, the present disclosure includes any other anti-theft feature available for mobile devices).

The kiosk then prompts the user to select the condition of the device. To simplify the user's decision-making process, the kiosk preferably only offers three options—Like New, Used, and Broken—and describes to the user what each option means. In the preferred embodiment, “Like New” means there are minimal scratches or wear marks on the device; “Broken” means the screen or the body of the device is cracked or broken; and “Used” means everything in between. This affords the user a simple way of determining the condition of the device without getting into complicated details. However, the kiosk may also offer more or fewer gradations of cosmetic condition; for example, it may distinguish between “Lightly Used” and “Heavily Used”, and so on.

The kiosk then instructs the user to plug in their device using one of several available connectors provided in the inspection area. In an embodiment, the type of connector the user chooses is the first step at identifying the device; the identification is automatically narrowed down to only those devices that use that type of connector. In another embodiment, the user does not plug in their device at all, but the kiosk makes wireless contact with the device instead. In that embodiment, the first-pass identification step of using the connector is, of course, unavailable.

The kiosk then communicates with the device through the connector (or wirelessly) to determine the ID of the device, read its serial number, and determine what type of device it is. All this information is received from the device rather than from external sources. The kiosk then displays the information received from the device on the screen and asks the user to confirm the information. In an embodiment, the kiosk then checks the device ID against one or more databases containing device ID's of stolen devices. Such databases may be hosted by law enforcement, cell phone carriers, or other public or private entities. If the device ID is found in one of those databases, the kiosk rejects the device. In an embodiment, the kiosk may also take additional steps of taking a picture of the user, alerting law enforcement, or alerting store personnel by sounding an alarm once the device is rejected.

In an embodiment, the user enters the device type and condition on a website prior to going to the kiosk to determine an appropriate price for the device. The website then generates an ID, bar code, or label for the user to print out or enter prior to going to the kiosk. The kiosk then verifies the type and condition of the device, and if they match what the user originally entered and if the device is not suspected to be stolen, the kiosk honors the price given by the website.

In an embodiment, the kiosk also checks the device ID in databases that store ID's of stolen devices. Such databases may include law enforcement databases, phone carrier “blacklist” databases, or privately owned databases. In such an embodiment, the device will be rejected if its device ID is found in such a database. The kiosk may also perform additional steps if a device ID is found to be in such a database, such as alerting law enforcement, taking a picture or video of the person attempting to sell the device, alerting the phone company, and so on.

The kiosk also communicates with the device to determine whether an anti-theft function such as “Find My iPhone” (or any similar anti-theft function available for electronic devices) is turned on. While this cannot be ascertained directly for the iPhone, it may be done indirectly as follows. The kiosk may ask the device for information normally blocked by anti-theft technology; if the device does not provide the information, it means that Find My iPhone is turned on. Alternately, the kiosk may provide the device ID to the Apple website and report a problem with the device; the response received from the Apple website, a request to disable Find My IPhone prior to service, the existence or absence of request may be interpreted to determine whether or not Find My iPhone is turned on.

If the anti-theft protection is turned on, the kiosk prompts the user to turn it off. If the user cannot turn it off, the kiosk rejects the device and optionally also sounds an alarm to alert store personnel, alerts law enforcement, takes a picture or video of the person attempting to sell the device, alerts the phone company, and so on. In an alternate embodiment, the kiosk simply rejects the device and takes no further steps.

In an embodiment, the kiosk also accesses stored fingerprint or other biometric information in a device that uses biometrics to control access, such as the iPhone 5. The kiosk then prompts the user to enter their own biometric information into the kiosk (for example, by means of a fingerprint reader or a retina scanner). If the biometric information received from the device does not match the biometric information received by the kiosk, the device is rejected. As before, the kiosk may also sound an alarm to alert store personnel, alert law enforcement, take a picture or video of the user, alert the phone company, and so on. In an alternate embodiment, the kiosk communicates its location to law enforcement along with any other pertinent information; law enforcement personnel can then be aware of the location of the potential thief at that moment in time.

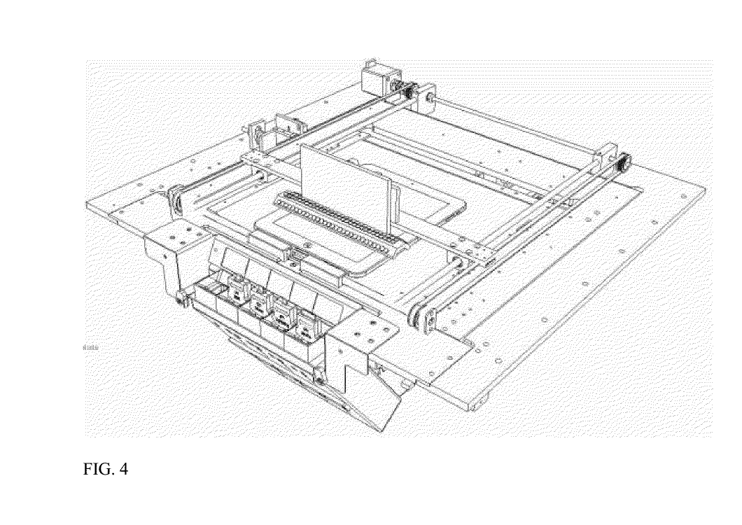

If the device is not rejected at that point, the kiosk then confirms the user's claims regarding the device's condition. In the preferred embodiment, the kiosk quickly examines the device using an array of light emitters and light sensors as shown in FIG. 4. The light sensors are positioned in such a way as to measure light reflected off the device's screen and light scattered by the device's screen. If the amounts of reflected light are relatively consistent throughout the device's surface, the device is classified as “Like New”; if the amounts of reflected and scattered light are very inconsistent, the device is classified as “Broken”; and anything in between is classified as “Used”. Other types of gradations may also be set.

A nonfunctional broken device will not be accepted by the kiosk, because the kiosk will be unable to communicate with the device. Repurchasing devices that are nonfunctional would encourage thieves to render stolen devices nonfunctional in order to resell them; thus, the kiosk of the present invention only accepts working devices. In an embodiment, the kiosk has a slot on the side to accept nonfunctional devices at no cost for recycling.

In the preferred embodiment, after confirming the user's claims regarding the device's condition, the kiosk prints out a barcode sticker to stick on the device, including a tracking number, to enable the device to be properly identified as it goes through the recycling process. The user is then prompted to stick the barcode sticker on the device.

After the device and the device's condition are verified, the kiosk offers a price to the user (assuming the user wishes to sell rather than donate the device). The price may be determined by a database stored in the kiosk itself, a database stored on the Internet to which the kiosk connects remotely, a formula or calculator stored in the kiosk or on the Internet, or by any other valuation methods known in the art. In an embodiment, the price may be determined by a human salesperson. After the user accepts the offer, the device is rendered inaccessible to the user (by closing the sliding doors 115, or by any other method).

The user is then prompted to perform an identification step. Such an identification step may involve scanning in the user's driver's license or other ID, scanning the user's fingerprint or retina, photographing and identifying the user's face, or any other form of identification. The identification is then stored in the kiosk's memory, in a database located on the Internet, on a cloud server, or in any other location, and associated with the device. In an embodiment, the photo on the ID may be compared with the user's face to make sure the user really is the person they say they are. The kiosk may also collect the user's signature and compare it to the signature on the user's driver's license or credit card.

The kiosk then reports the transaction to any government agency as required by law for secondhand dealers. It may automatically generate a form for the customer to sign, automatically report the transaction to any online service used by the government, or perform any other steps required by law to report the transaction.

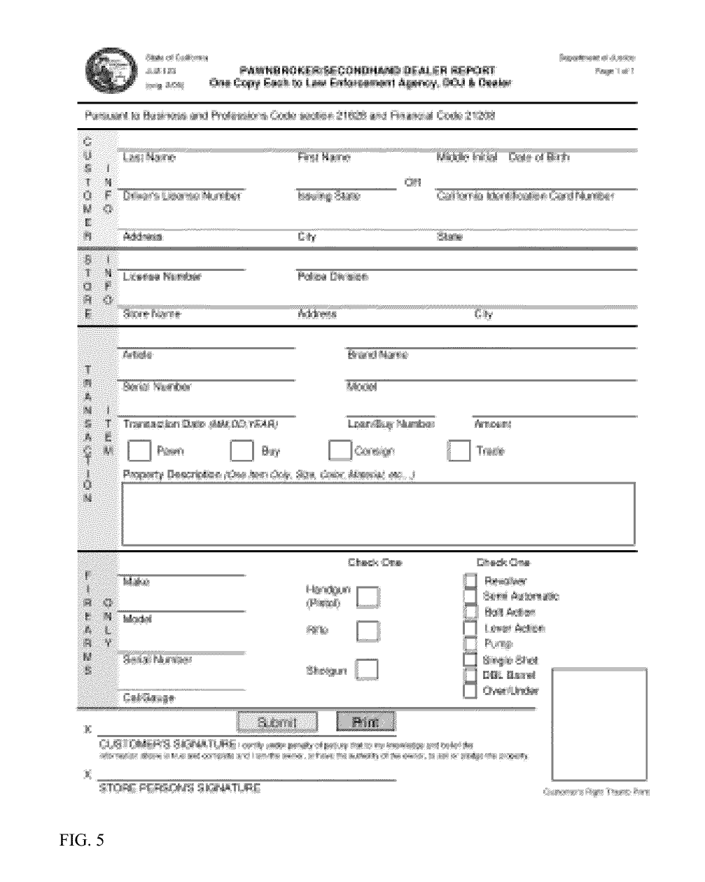

FIG. 5 shows a sample JUS123 form used for reporting secondhand transactions to law enforcement in California. As can be seen, this particular form requires the user's name, address, driver's license number and state, the store's license number, name, address, and police division, information about the secondhand item being sold and the transaction date, and the customer's and salesperson's signature. The form also requires the customer's right thumb print. In the preferred embodiment of the present invention, all of this information is automatically collected by the kiosk and used to generate the form.

After the form is generated, it is then submitted to law enforcement. In some jurisdictions, the form has to be mailed to the appropriate department of the local law enforcement agency. The kiosk therefore may have the capacity to print out the required form and prepare it for mailing. For example, it may comprise a device for automatically folding the form, putting it into an envelope, and stamping it. In another embodiment, the kiosk simply prints the forms, and a worker comes daily and collects those forms for mailing.

In some jurisdictions, it is possible to submit secondhand transaction forms electronically. For example, some jurisdictions in California use the California Pawn and Secondhand Dealer System (CAPSS) for electronically submitting data on secondhand transactions to the Department of Justice. In those jurisdictions and other jurisdictions that use similar electronic reporting systems, the kiosk preferably comprises a connection to the Internet, and the kiosk's processor preferably comprises programming that enables it to compile the information submitted by the customer in the right form for submitting to such an electronic reporting system.

Finally, the user is prompted to accept payment. Payment may be dispensed by transferring funds to the user's credit card or bank account, automatically dispensing a ticket that can be redeemed for cash, web-based payment services, near-field communications with the user's mobile device, or other means of dispensing payment known in the art. The device is drawn into a receptacle located within the kiosk, and sent to a recycling facility, a resale facility, or any other destination. The kiosk can also display and print the receipt for the transaction.

In an embodiment, the same functions are performed by a desktop device rather than a kiosk. The desktop device is preferably located on the counter of a retail store, and is used to identify the device, perform a functional test on the device, determine whether or not the device is likely to be stolen, and collect any information required by law enforcement to report the secondhand transaction. The desktop device then either prints out a form usable for reporting the secondhand transaction, or transmits an electronic file to law enforcement.

While exemplary embodiments have been described above, those skilled in the art will readily realize that numerous changes, modifications, and substitutions may be made without departing from the spirit and scope of this invention, which is limited only by the appended claims.

1. A system for recycling electronics, comprising:
a kiosk housing;
a device examination area;
a user interface;
a processor;
wherein the processor is configured to communicate with an electronic device placed in the device examination area, said electronic device selected from a group comprising smartphones, cell phones, mp3 players, mobile computers, portable games;
wherein the processor is configured to identify the brand, model, and serial number of the electronic device;
wherein the processor is configured to determine whether the electronic device rightfully belongs to a user;
wherein the processor is configured to reject the electronic device if it cannot be determined that it rightfully belongs to the user;
wherein the processor performs a functional test on the electronic device;
wherein the processor is configured to determine an appropriate compensation value for the device solely based on the information received from the electronic device and from the user and offer the compensation value to the user;
wherein the processor is configured to collect any information from the user required by local law enforcement;
wherein the processor is configured to automatically generate a report of the secondhand transaction for law enforcement;
wherein the processor is configured to transmit the report of the secondhand transaction to law enforcement.

2. The system of claim 1, wherein the system further comprises:
a printer;
wherein the processor is configured to direct the printer to print out at least one form required by law enforcement for reporting secondhand transactions.

3. The system of claim 1, wherein the system further comprises:
a fax machine;
wherein the processor is configured to transmit the report of the secondhand transaction to law enforcement by fax.

4. The system of claim 1, wherein the system further comprises:
at least one biometric device;
wherein the processor is configured to collect information from the at least one biometric device for the purpose of reporting secondhand transactions to law enforcement.

5. The system of claim 3, wherein the biometric device is at least one of the following group: a fingerprint reader, a retina scanner, a face scanner.

6. The system of claim 1, wherein the system further comprises:
a scanner;
wherein the processor is configured to direct the scanner to scan a user's ID for the purpose of reporting secondhand transactions to law enforcement.

7. A method of recycling electronics, comprising:
receiving an electronic device from a user, said electronic device selected from a group comprising smartphones, cell phones, mp3 players, mobile computers, portable games;
communicating with the electronic device;
determining the brand, model, and serial number of the electronic device;
determining whether the electronic device belongs to the user;
rejecting the electronic device if it is determined that the electronic device does not belong to the user;
performing a functional evaluation of the electronic device if it is determined that the electronic device belongs to the user;
performing a cosmetic evaluation of the electronic device if it is determined that the electronic device belongs to the user;
determining a compensation value for the electronic device based on the identification of the electronic device, the functional evaluation, and the cosmetic evaluation;
offering the compensation value to the user;
collecting identification information from the user;
using the identification information to generate a form for reporting a secondhand sales transaction to law enforcement;
transmitting the form to law enforcement.

8. The method of claim 6, wherein the identification information collected from the user comprises at least one of the following:
an image of an identification document;
a fingerprint;
a signature;
a retinal scan;
the user's name;
the user's address;
the user's date of birth;
an image of the user's face.

9. The method of claim 7, wherein the step of using the identification information to generate a form comprises printing out a paper form, and the step of transmitting the form to law enforcement comprises mailing the paper form.

10. The method of claim 7, wherein the step of using the identification information to generate a form comprises generating an electronic file, and the step of transmitting the form to law enforcement comprises transmitting the electronic file via the Internet.

11. The method of claim 7, wherein the step of transmitting the form to law enforcement comprises faxing the paper form.

12. A system for recycling electronics, comprising:
a housing no greater than 1 foot by 1 foot by 6 inches in size;
a device interface;
a user interface;
a communication module;
a processor;
wherein the processor is configured to communicate with an electronic device connected to the device interface, said electronic device selected from a group comprising smartphones, cell phones, mp3 players, mobile computers, portable games;
wherein the processor is configured to identify the brand, model, and serial number of the electronic device;
wherein the processor is configured to determine whether the electronic device rightfully belongs to a user;
wherein the processor is configured to reject the electronic device if it cannot be determined that it rightfully belongs to the user;
wherein the processor performs a functional test on the electronic device;
wherein the processor is configured to determine an appropriate compensation value for the device solely based on the information received from the electronic device and from the user and offer the compensation value to the user;
wherein the processor is configured to collect any information from the user required by local law enforcement;
wherein the processor is configured to automatically generate a report of the secondhand transaction for law enforcement;
wherein the processor is configured to transmit the report of the secondhand transaction to law enforcement via the communication module.

13. The system of claim 10, wherein the system further comprises:
a printer;
wherein the processor is configured to direct the printer to print out at least one form required by law enforcement for reporting secondhand transactions.

14. The system of claim 10, wherein the system further comprises:
at least one biometric device;
wherein the processor is configured to collect information from the at least one biometric device for the purpose of reporting secondhand transactions to law enforcement.

15. The system of claim 12, wherein the biometric device is at least one of the following group: a fingerprint reader, a retina scanner, a face scanner.

16. The system of claim 10, wherein the system further comprises:
a scanner;
wherein the processor is configured to direct the scanner to scan a user's ID for the purpose of reporting secondhand transactions to law enforcement.
